(19) United States
(12) Patent Application Publication
(10) Pub. No.: US 2012/0221371 A1
(43) Pub. Date: Aug. 30, 2012

(54) SYSTEM, METHOD AND COMPUTER PROGRAM FOR ASSET MANAGEMENT OPTIMIZATION

(76) Inventors: Tarek Hegazy, Waterloo (CA); Ahmed A.M.E. Elhakeem, Cairo (EG)

(21) Appl. No.: 13/380,697

(22) PCT Filed: Jul. 2, 2010
(86) PCT No.: PCT/CA2010/001018

§ 371 Date: May 14, 2012

Related U.S. Application Data
(60) Provisional application No. 61/213,681, filed on Jul. 2, 2009.

(51) Int. Cl. G06Q 10/06

(52) U.S. Cl. 705/7.25

(57) ABSTRACT

The present invention provides a visual asset management system for optimizing inspection and allocation of capital renewal (repair/rehabilitation/replacement) resources among a plurality of assets wherein each asset has a different life cycle. Inspection is enabled by an inspection device that enables a user to access an inspection template for conducting an inspection of assets. The user can provide inspection data via the inspection device, including by providing images of particular assets to represent their life cycle performances. An optimization engine conducts a two stage optimization on the inspection data, first by optimizing inspection and allocation of renewal resources on an asset by asset basis, and then by optimizing inspection and allocation of renewal resources among all assets or a sub-set of the assets.

### FIELD OF THE INVENTION

The present invention relates generally to asset management optimization. The present invention more specifically relates to asset management optimization managing the renewal of a plurality of assets, each having a life cycle, which optimizes the allocation of inspection and funding resources across the various renewal requirements.

### BACKGROUND OF THE INVENTION

Civil infrastructure assets, such as roads, bridges, airports, and building facilities such as educational buildings and hospitals are essential to the growth and prosperity of the economy, as well as the welfare of residents. With many assets getting old, sustaining their healthy operation becomes a great challenge, particularly under constrained budgets for asset renewals. To care for these important assets, municipalities and large organizations require proper asset management tools to support the perpetual cycle of inspection, analysis, fund allocation, and implementation of asset renewal plans. The same needs exist for owners of any group of assets, whether civil infrastructure owners, fleet owners or any other owner of asset inventories.

In general, asset owners have two functions to care for their asset inventory: preventive/reactive maintenance; and capital asset renewal (FIG. 1). While maintenance functions support day-to-day operations, capital asset renewal upgrades, repairs, rehabilitates, or completely replaces the asset, or some of its components.

Performance is determined as the combination of various categories including physical condition, Level Of Service, Risk of Failure, Sustainability, and Green performance (note that “performance” is herein used interchangeably with “condition” of an asset).

Sustaining the serviceability and safety of infrastructure networks is a highly challenging task, particularly under stringent budgets. Various asset management tools have therefore been introduced to help asset managers in the difficult decisions regarding how and when to repair/replace their existing building stock cost-effectively. While existing systems involve partial solutions such as condition assessment surveys, CAD and/or GIS, there still exists considerable difficulties related to the formulation of an integrated life cycle analysis that considers both asset-level and network-level decisions.

Several key procedures are involved in the ideal asset management process: creating and maintaining databases of all assets' data; condition inspection and assessment; calculating assets' condition deterioration with time; defining and calculating the cost of optional repair strategies; calculating the condition improvement due to any repair strategy; and selecting best repair methods and select the most critical assets to repair considering the best value for money over the long term (called life cycle analysis). Any inadequate or missing procedures, and/or mismatch or lack of coordination among these procedures, affects the quality and cost implications of asset management decisions.

To this day, municipalities, asset owners, and accordingly all tax payers face technical challenges within each function in the asset management process, including four key technical challenges with large cost implications: (a) the difficulty in coordinating data and decisions among the different functions from inspection to life cycle analysis; (b) the large time and cost of current manual and subjective processes to inspect all the sub-assets (sub-components) of all assets, indiscriminately; (c) the difficulty in integrating and optimizing both the repair/no-repair (network-level decision) and the repair-type (project-level decision) simultaneously for a large number of assets; and (d) the difficulty in tracking and visualizing the large amount of data across the asset inventory to facilitate trend analysis and decision making.

For example, inspection surveys can be carried out at various levels of details. A direct rating of an asset typically gives a direct category of condition such as: Good, Fair, Poor, or Critical. A more detailed deficiency-level requires assessment of various defects, for example, window fogging, window frame problem, window handle problem, etc. A distress-based inspection, on the other hand, is also detailed and evaluates an asset against a list of generic distresses, such as: broken, malfunction, etc. Even though the inspection data indicates the specific area to be repaired, current methodologies do not utilize this data from one step to the other to facilitate better decisions. As such, deterioration models, repair models, and fund allocation models do not utilize this data and thus end up conducting approximations and less optimum decisions.

While current condition (i.e., defect severities) can be accurately inspected, the future condition (future severities) of any instance is difficult to predict and is basically a function of aging, operational conditions, maintenance history, etc. Various deterioration models, therefore, have been proposed in the literature and used in asset management systems.

Even when conditions are known, it is extremely difficult to decide the best repair type for each asset (asset-level decision) and also to prioritize and select which assets among the whole network of assets to repair (or not to repair) in each year (called network-level decisions) over a number of years (called planning horizon). It is conceivable that the choice of which repair strategy to use for an asset depends in large part on when the repair is planned so that the repair becomes suitable for the condition of the asset at that time. However, because of the thousands of sub-assets involved in addressing many assets, it becomes difficult to combine all asset-level and network-level decisions into one life cycle formulation. Disjointed inspection results in inspection data that is not up to date or conclusive and ends up with many components being classified as critical, without indication if some components have more impact on operation, safety and other performance criteria. This complicates and randomizes the fund allocation task, which is based on simply ranking without any optimization.

U.S. Pat. No. 7,058,544 to Uzarski teaches a condition survey inspection framework and procedure. Uzarski teaches a mechanism to determine the type of inspection that should be done at each stage in the life cycle of a property. However, Uzarski does not provide any detailed methodology or device to conduct these inspections. This renders the teachings of Uzarski as unrealistic, expensive and time consuming.

Therefore, what is required is a technology for managing the renewal of a plurality of assets, each having a potentially different life cycle, which enables optimization of allocation of inspection and funding resources across the various renewal requirements. What is also required is a means to achieve this with low time and cost. What is also required is a device to facilitate such optimization.

### SUMMARY OF THE INVENTION

The present invention provides a visual asset management system for optimizing inspection and allocation of capital renewal resources among a plurality of assets, at least two of the assets having different life cycles, the visual asset management system characterized by: an inspection device linkable to an asset management database operable to store a life cycle performance for each of the plurality of assets, the inspection device comprising: an inspection software utility that enables a user of the inspection device to (a) access an inspection template for conducting an inspection of the plurality of assets, and (b) collect and/or generate inspection data associated with a life cycle performance of the plurality of assets, the inspection data including one or more images representative of the life cycle performance of particular assets; wherein the inspection device links or facilitates linking the inspection data with the corresponding asset in the asset management database so as to enable the analysis of the inspection data, including for allocation of renewal resources among the plurality of assets, or a sub-set of such assets.

The present invention also provides a visual asset management system for optimizing inspection and allocation of renewal resources among a plurality of assets, at least two of the assets having different life cycle, the visual asset management system characterized by: an asset management database operable to store a life cycle performance for each of the plurality of assets; an optimization engine linked to the asset management database; and an inspection device linked to or linkable to the asset management database, the inspection device operable to enable a user thereof to: (a) access an inspection template for conducting an inspection of the plurality of assets, and (b) collect and/or generate inspection data associated with a life cycle performance of the plurality of assets, the inspection data including one or more images representative of the life cycle performance of particular assets; wherein the inspection device links or facilitates linking the inspection data with the corresponding asset in the asset management database so as to enable the analysis of the inspection data, including allocation of renewal resources among the plurality of assets, or a sub-set of such assets.

The present invention also provides an asset management method for optimizing inspection and allocation of renewal resources among a plurality of assets, at least two of the assets having different life cycles, the asset management method characterized by: (a) analyzing historical data for each asset to generate a pool of repair decisions for each of one or more renewal periods; and (b) optimizing the repair decisions across all the assets in accordance with one or more constraints to allocate renewal of resources among all the assets for each of the renewal periods.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### DESCRIPTION OF THE DRAWINGS

FIG. 1 illustrates prior art asset maintenance and repair in accordance with the prior art.

FIG. 2 illustrates a system in accordance with the present invention.

FIG. 3 illustrates an example of an inspection device in accordance with the present invention.

FIG. 4 illustrates an example of an asset hierarchy.

FIG. 5 illustrates an example of an asset management data structure.

FIG. 6 illustrates an example of the user interface of the inspection system.

FIG. 7 illustrates a custom deterioration curve for an individual asset instance.

FIG. 8 illustrates the second step of the deterioration model, in which the predicted future DI from the first step may be converted into corresponding defect severities.

FIG. 9 illustrates an example of future severities.

FIG. 10 illustrates the MOST analysis.

FIG. 11 illustrates a repair scenario for an asset having four deficiencies

FIG. 12 illustrates determination of replacement cost.

FIG. 13 illustrates expected performance as the average of the DI values of the various years.

FIG. 14 illustrates network-level optimization carried out using three alternatives.

FIG. 15 illustrates an example of applying year-by-year binary optimization using Genetic Algorithm based on historical data for all assets in the asset network.

FIG. 16 illustrates the results optimization on networks with large numbers of instances.

FIG. 17 shows a portion of a simple statistical analysis.

FIG. 18 illustrates an example of historical data for a sample of 88 schools.

FIG. 19 illustrates a subset of the data shown in FIG. 18.

FIG. 20 illustrates a further subset of the data shown in FIG. 18.

FIG. 21 illustrates a further subset of the data shown in FIG. 18.

FIG. 22 illustrates logical trends revealed in the optimization.

FIG. 23 illustrates two indicators of asset condition.

FIG. 24 illustrates comparison between the predictions of condition based on cost versus those based on the number of work orders.

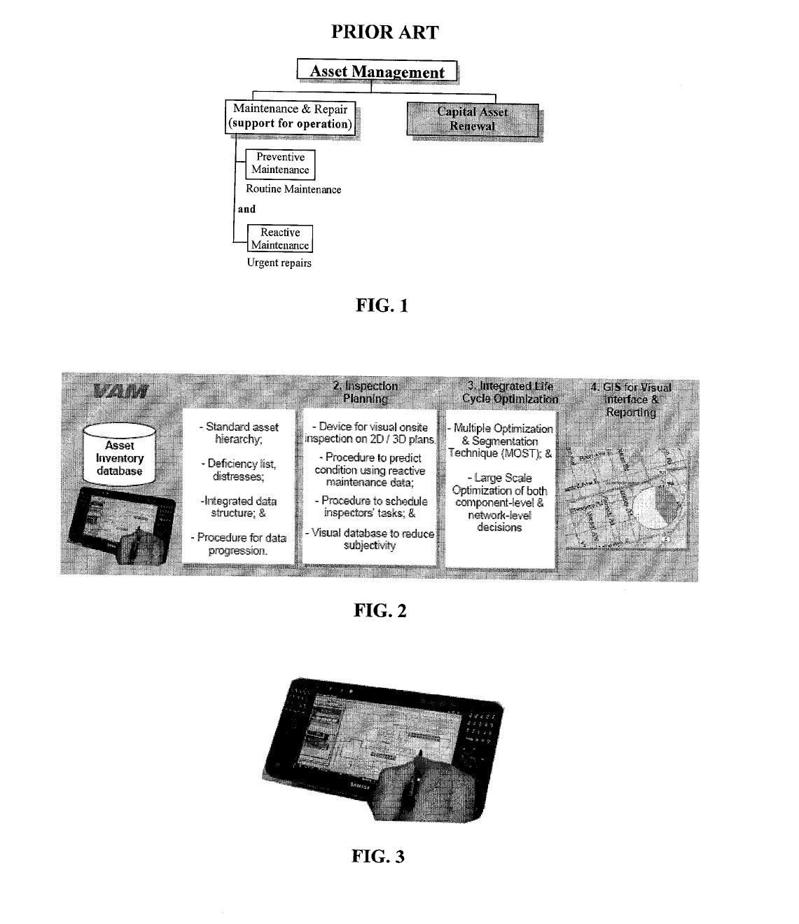

### DETAILED DESCRIPTION

The present invention provides a system, method and computer program for visual asset management optimization. More specifically, the present invention enables management of the renewal of a plurality of assets, each having a life cycle, which optimizes the allocation of inspection and funding resources across the various renewal requirements. The phrase “asset management” is used herein to refer to capital asset renewal. Correspondingly, the term “renewal” is used herein to refer to repair/rehabilitation/replacement of an asset which is intended to improve the condition and the overall performance of the asset. Among the plurality of assets, one or more of the assets may have different requirements than one or more of the other assets. For example, the present invention can be applied to asset management for civil infrastructure, fleet owners or any other owner of asset inventories, such as in oil and gas (pipelines), industrial facilities (such as manufacturing, processing facilities), bridges, nuclear facilities, power distribution, highway renewal etc. The present invention also enables visual asset management in which 2D, 3D, video, GIS, and/or sensor systems may be used to collect, analyze, support, and visualize asset management data and decisions at all levels of decision making.

The present invention provides a method of optimizing and an optimization engine for optimizing, the allocation of resources across the various requirements. The optimization engine applies a two stage optimization algorithm that is operable to conduct optimization that would otherwise require significant time and computer resources. The optimization algorithm may be a Multiple Optimization and Segmentation Technique (MOST), which acts as a strategic decision support to optimize decisions, quantify the impact of various funding scenarios on asset performance, and conduct a variety of what-if scenarios. The optimization algorithm may begin by conducting a set of small asset-by-asset optimizations (instance-level) that determine the optimum repair scenarios for the particular asset in different years, or any other renewal frequency as determined by the asset owner. The resulting pool of best yearly repairs may then be used as inputs to the network-level, to formulate yearly optimizations, which determines the assets worthy of repair. As such, both repair timings as well as repair types are optimized within optimizations of a manageable size. It should be understood that while the disclosure discusses the use of a year as a renewal frequency, any renewal frequency could be used.

The optimization algorithm may conduct instance-level optimization based on historical data, which may include maintenance and repair data for the specific assets provided by the asset owner.

The present invention also provides an inspection planning utility that links inspection data with visualization data to enable the identification and localization of specific performance and renewal issues. The inspection data may correspond to categorization of renewal issues and the visualization data may include images, video, GIS and/or other sensor data to enable the identification and localization of the renewal issues. The images, for example, may enable the rating of severity of renewal issues for example by comparing them to other specific renewal situations. In a specific example, the categorizations for specific renewal issues may be “low priority”, “medium priority” or “urgent”. A renewal issue may correspond to a roof, for example, and the renewal issue may be reviewed easily by a manager by reviewing the priority and checking the linked image to verify the justification of the prioritization. The inspection planning utility may also enable auditing of results by selective review of images, etc.

The present invention enables renewal-based asset management for a plurality of assets that each have a life cycle, which can vary among the assets. The present invention enables performance assessment, deterioration modeling, repair selection, prioritization, and fund allocation. The optimization engine tracks the dynamics of defects in each asset instance and uses a Multiple Optimization and Segmentation Technique (MOST) to efficiently integrate instance-based and network-based life cycle analyses.

FIG. 2 illustrates a system in accordance with the present invention. The system may be implemented by a server computer linked to an asset management database, which may be one or more centrally located or distributed databases. The server computer may further include or be linked to: (1) a data coordination utility; (2) an inspection planning utility; (3) an optimization engine; and (4) a visual reporting utility.

The server computer may be accessible by an inspection device, for example by wireless real time access to the server computer by the inspection device or periodic synchronization between the server computer and inspection device, for example by a wired or wireless synchronization link. FIG. 3 illustrates an example of an inspection device in accordance with the present invention. The inspection device may include a display means and an input means, such as a keyboard, stylus or touch screen for example. The inspection device may also include or be linkable to an image, obtaining means, such as a camera. The inspection device may also include a positioning means, such as a GPS receiver, and other sensors, to assist in asset identification. A user may operate the inspection device to access the server computer by means of the inspection planning utility.

The inspection device may enable, be linked to, or be part of a visual asset management system for optimizing inspection and allocation of renewal resources among a plurality of assets, wherein at least two of the assets have different life cycles. The inspection device may be linkable to the asset management database, for example by means of the server computer. The asset management database may store a life cycle performance for each of the plurality of assets. The inspection device may comprise an inspection software utility that enables a user of the inspection device to (a) access an inspection template for conducting an inspection of the plurality of assets, and (b) collect and/or generate inspection data associated with a life cycle status of the plurality of assets. The inspection data may include one or more images representative of the life cycle status of particular assets, for example indicating a time stamped image indicating state of repair or state of renewal of the particular asset, or a particular portion of the asset. The inspection device may link or facilitate, for example by communication with the server computer, linking the inspection data with the corresponding asset in the asset management database so as to enable the analysis of the inspection data, including for allocation of renewal resources among the plurality of assets, or a sub-set of such assets.

The inspection device may, for example, consist of a handheld computing device. Optimally, the inspection device is a wireless handheld computing device, whether a purpose built device or a wireless handheld computing device that includes a client application for providing the functions described or a mobile browser that is operable to access the functions described via a remote server computer over an Internet connection made available to the device. The inspection device may be, for example, a laptop, tablet, smartphone, slate computer, etc. equipped with a processor capable of executing the inspection software utility. Alternatively, the inspection device may be linked by network to a remote processor that is operable to execute the inspection software utility, for example in a cloud-based implementation.

The visual inspection template may include a floor plan of a facility that includes one or more of the plurality of assets. The floor plan may be a two dimensional image or a three dimensional model for example. The user may select the asset for inputting inspection data by selecting the asset on the inspection device, such as by selecting it on the display means. The inspection data may comprise a condition category for the asset and/or one or more images obtained by the image obtaining means. The inspection device may further comprise a positioning means that facilitates identification of assets on the visual inspection template. The positioning means may be a geo-location utility for obtaining location data linkable to the inspection data so as to enable the localization of the assets and/or inspection data for the assets that relate to renewal requirements.

The inspection data stored in the asset management database can be used by the optimization engine for optimizing inspection and allocation of renewal resources among the plurality of assets, or a sub-set thereof. The optimization engine may further optimize inspection and allocation of renewal resources based on historical data. The historical data may include preventive and reactive maintenance and repair data for the assets.

The optimization engine may apply a two stage optimization algorithm. The first stage may be operable to optimize the inspection and allocation of renewal resources on an asset by asset basis. The second stage may be operable to optimize the inspection and allocation of renewal resources across the plurality of assets based on the optimization from the first stage and one or more resource constraints. The resource constraints may include budget constraints.

Optimizing inspection may include optimizing an inspection schedule. The inspection schedule may restrict inspection of the plurality of assets to a subset of the plurality of assets for a particular inspection period. The subset of the plurality of assets may be selected by analyzing the historical data for the assets to determine likely deterioration of each of the assets.

The data coordination utility may be accessed by a user interface from the server computer or optionally the inspection device. The data coordination utility may enable creation of an asset instance for each asset. The data coordination utility may enable an administrator (such as the owner, or an agent of the owner, of the plurality of assets) to create asset instances for each type of asset. Each asset instance may include a name, description or index for the asset instance and performance assessment data, which may include at least one inspection resource, at least one renewal strategy, at least one performance category, at least one deficiency and at least one distress along with importance weights according to desired inspection detail. Performance categories include physical condition, Level Of Service, Risk of Failure, Sustainability, and Green performance. Renewal strategies, deficiencies, distresses and weights may be configured based on historical data for the specific asset instance, asset, class of asset, location of asset, or other aspect of the asset instance.

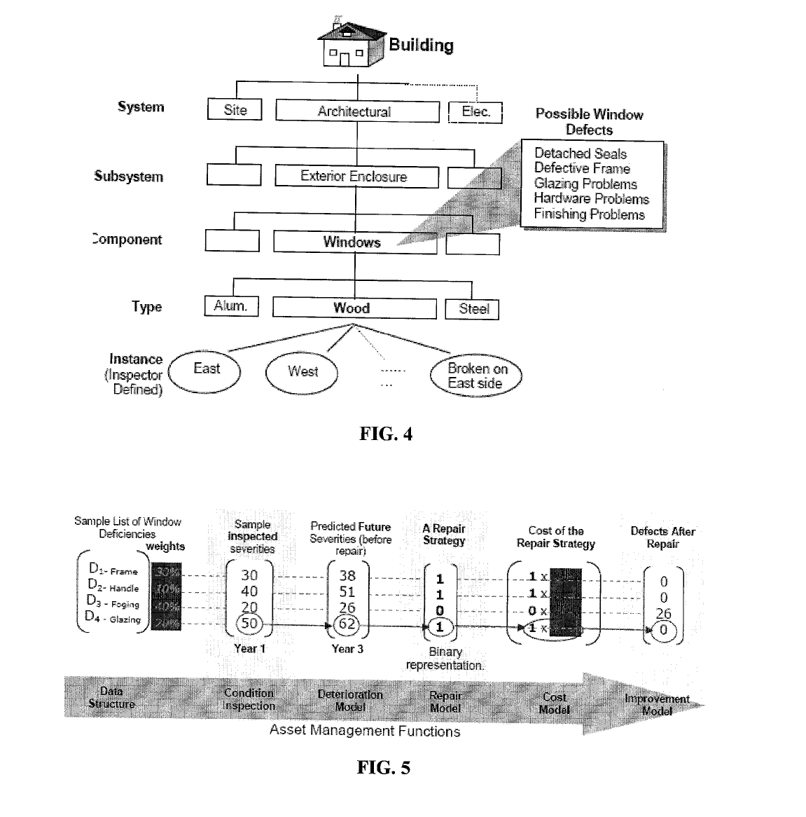

The administrator may create an asset hierarchy for one or more of the asset instances. The hierarchy may correspond with the use of the asset instance among other assets instances (for example, an asset instance that is a subcomponent of another asset instance may be related in a child-parent relationship in the asset hierarchy). An example of an asset hierarchy is illustrated in FIG. 4.

The created asset instances and associated asset hierarchy may be stored to an asset management data structure on the asset management database. The asset management data structure may enable further input of various conditions, defects and/or distresses, along with their severity level, size, and visual locations that may be entered during inspection. An example of an asset management data structure is shown in FIG. 5. In this example, specific defects can be defined during inspection and defects can be increased in deterioration yearly. A repair strategy may be represented as a binary vector that responds to the most severe defects. Accordingly, repair costs may be calculated and after-repair defects may be set to zero, indicating an improved condition.

During inspection, the data coordination utility enables performance assessment. Performance assessment can be performed using various methods including: visual inspection, photographic and optical methods, non-destructive evaluation methods, and smart sensors. Among these methods, visual inspection may be a most suitable approach for the majority of building assets.

Correspondingly, the visual reporting utility may provide a comprehensive GIS-based visualization subsystem to provide asset owners with powerful location-based reports. It may automate the generation of visual reports that show all details across the asset inventory. This enables better visualization of all data and decisions of the entire asset inventory such as chronological condition changes, expenditure variations, demographical factors, etc.

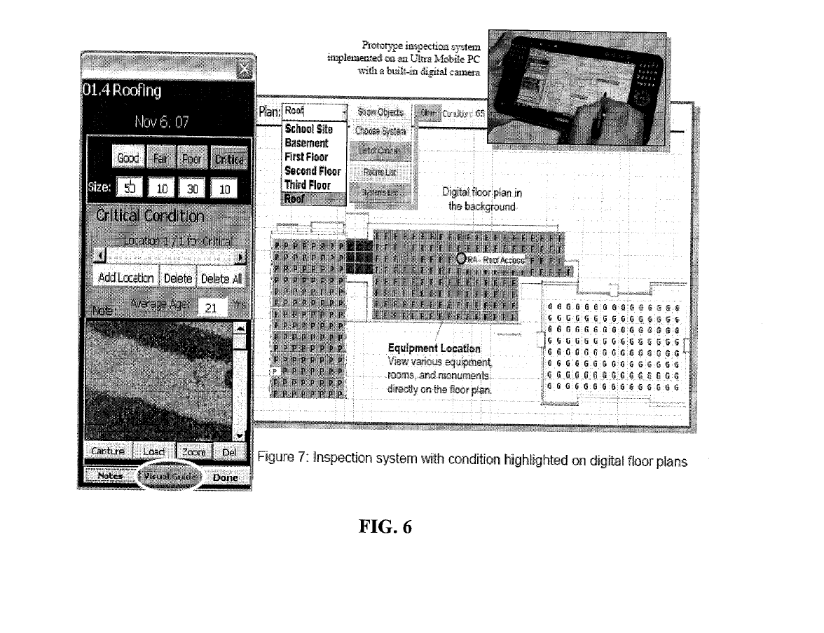

The inspection device enables visual inspection and visual reporting in accordance with the present invention. The inspection device may provide a user interface to provide a user with: (1) an asset hierarchy of asset instances and components of asset instances; (2) color coding to mark the location of Good, Fair, Poor and Critical (or other rating system) items directly on a digital floor plans; (3) means to provide images, for example using a built-in digital camera, to effortlessly capture and store pictures of inspected items in its associated asset database location; and (4) a built-in pictorial database of assets at different conditions, as a visual guidance during inspection to reduce subjectivity. An example of the user interface of the inspection system is shown in FIG. 6.

For a detailed condition assessment, the inspector may for example evaluate the severity of various defects associated with the asset or asset instance being inspected asset (e.g., Boiler no. 1, or a group of East-side aluminum windows, etc.). Asset instances may be defined by the user (inspector) to represent a group of similar objects that belong to a certain asset. The inspection process, which can also be referred to as a distress survey, may compute the deterioration level of an instance depending on the observed severity levels entered during inspection. Based on the inspected severities for an instance with (d) possible defects, a Deterioration Index (DI), on a scale from 0 to 100 for example, may be calculated. A DI value of 0 may imply excellent condition (no deterioration), while a DI of 100 may imply an extremely critical condition. DI may be calculated by the formula:

$$D I = \frac{{\sum }_{i = 1}^{d} {W}_{i} \cdot {S}_{i}}{100} \qquad ( 1 )$$

Where (Sᵢ)s are the inspected severities on a scale from 0 to 100, and (Wᵢ)s are the weights of the various defects, which reflect their relative impacts on the overall condition of the instance. The weights may be obtained through historical data. It should be noted that the defects with highest severities (Sᵢ)s reflect the areas where repair is most necessary. The severities also increase (i.e., get worse) with time, according to a particular deterioration pattern, and accordingly repair needs may change. These increases may also be obtained through historical data.

The inspection planning utility may be accessed from the inspection device. The inspection planning utility may include a graphical user interface that displays to a user, by means of the inspection device, a two or three dimensional plan of the asset, facility in which the asset instance is located and/or environment surrounding the asset instance. A user of the inspection device may select the asset instance, for example by the input means of the inspection device, and provide the inspection device with images of the asset instance taken during inspection, for example by the image obtaining means. The images may be linked to the asset by the inspection planning utility to create a visual database (2D, 3D, and/or video) of historical cases of various asset conditions as guidance for future inspection. The images may also be linked to the asset instance in the asset management data structure for recalling the image during post-inspection verification, for example by a supervisor to confirm that the correct deterioration rating has been indicated. The positioning means of the inspection device may also be used to provide location information of the asset instance in the asset management data structure.

The optimization engine may prioritize inspection and renewal of the asset instances. The optimization engine may provide a two stage optimization algorithm that includes condition prediction, deterioration analysis and/or MOST analysis.

Condition prediction may use historical data to develop indicators of asset condition, without inspection. This reduces the amount of indiscriminate and resource demanding inspection visits and identifies and directs available inspectors towards top priority assets. Condition prediction applies historical data to develop an automated condition prediction system for assets. Using statistical analysis on the historical data, two indicators of condition may be determined: (1) the number of the previous year's work orders for the asset based on the historical data; and (2) the total cost of the previous year's work orders for the asset based on the historical data. Based on these two indicators, threshold values for each condition category may be determined. For any asset instance, when the condition prediction is the same from the two indicators (i.e., poor condition), then it may be considered certain that the asset instance is in poor condition, without inspection. On the other hand, when the condition indicators provide conflicting estimates, particularly if one indicates a poor or critical condition, then the asset instance may be highly prioritized for inspection. Once all top priority asset instances are identified, the procedure may then schedule the work of the inspectors among them to conduct inspection, refine the data and confirm asset condition.

Historical data is used not only to develop a generic model for predicting the deterioration of an asset (e.g., roof), but also to customize the generic model to each instance of that asset (e.g., old Gymnasium roof for School no. 9). As shown in FIG. 7, a Markov Chain approach may be used to generate deterioration curves for the asset based on historical data for the asset instances.

The deterioration analysis may provide a custom deterioration curve for each asset instance by optimizations based on the condition assessment data and historical data. The deterioration analysis may be initiated whenever a user updates condition assessment data for an asset instance. The custom deterioration curve may consider the implicit impact of the operational environment of each asset instance and any unforeseen parameters that affect the asset instance's rate of deterioration. The custom deterioration curve not only predicts the future deterioration index of an asset instance in any year but may also translate this future deterioration into predicted severities of defects, which may define specific repair needs in that year.

The custom deterioration curve is developed for each individual instance, knowing its specific inspection history. In the particular example shown in FIG. 7, an asset instance is the aluminum windows on the east-side of a specific school. The Markov Chain optimization may then be used to determine the values in the Transition Probability Matrix (TPM) that generate a deterioration curve that best corresponds to the data trend, and the previously inspected DIs for that asset instance (two points shown). This approach to deterioration modeling is more advantageous than using a generic curve for an asset, as it considers the variability in performance among asset instances and the impact of their specific operational environment. Once the custom deterioration curve is developed, it can be used to predict (extrapolate) the DIs in future years of the planning horizon. These future DIs may represent the deterioration indexes under no-repairs.

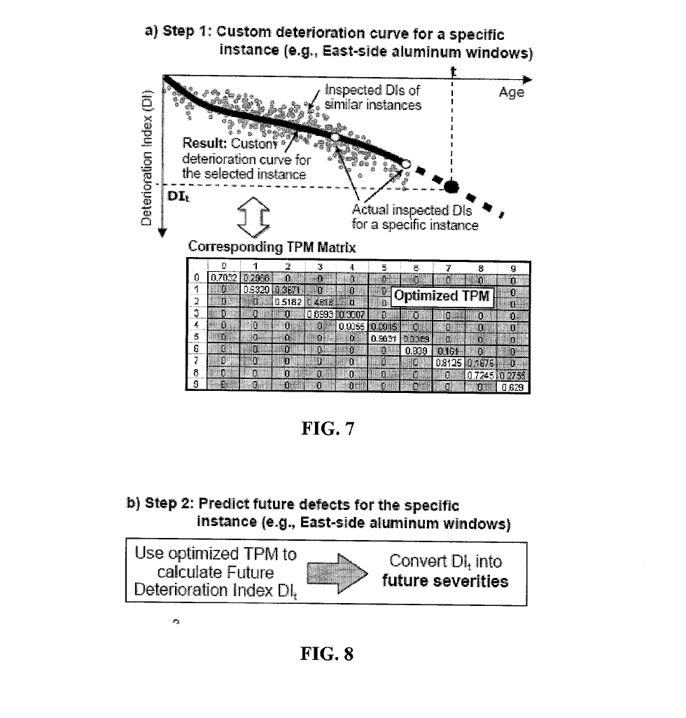

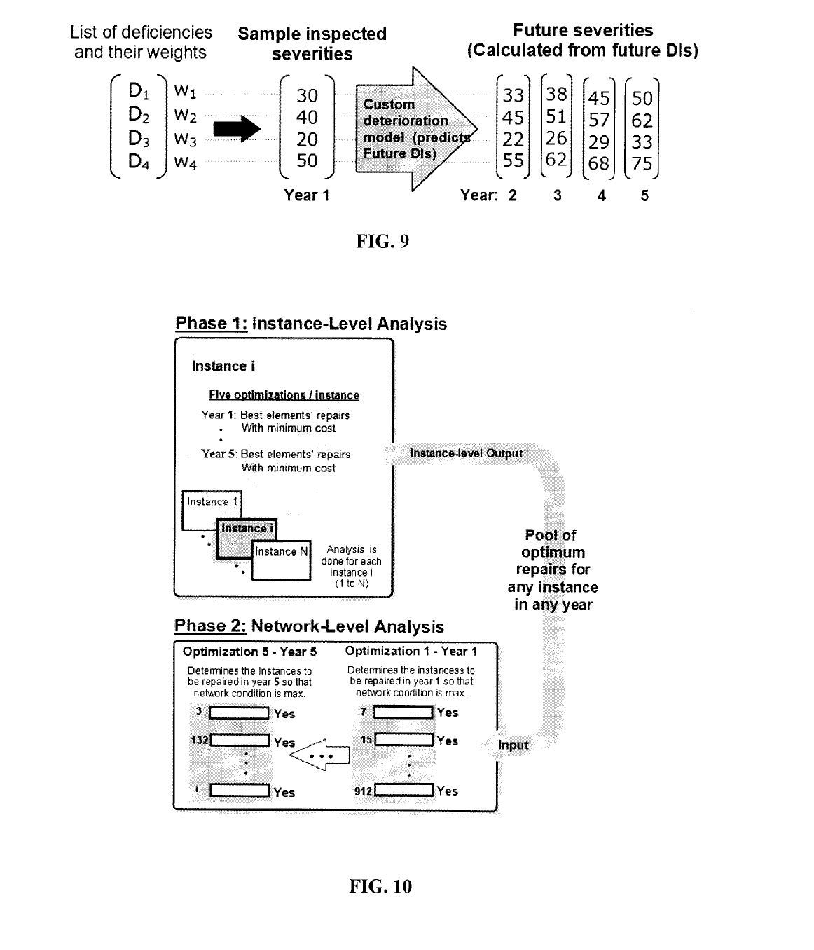

FIG. 8 illustrates the second step of the deterioration model, in which the predicted future DI from the first step may be converted into corresponding defect severities. Since DI increases with time (i.e., condition worsens), the deficiencies may be expected to reflect increase in the severities. The calculation of the future severities, however, is not a straightforward task. One practical approach is to increase the inspected severities (e.g., year 1 in FIG. 8) proportional to their relative values, so that Eq. 1 is used to determine the predicted (DI) in future years. Once the future severities are determined, they may represent defined defects that need to be repaired in the future. An example of future severities is illustrated in FIG. 9.

The MOST analysis simplifies the integration of project-level and network-level decisions in large-scale networks of assets. The MOST analysis is illustrated in FIG. 10. In essence, it applies many small-size optimizations at the project-level (asset instance level) to generate a pool of best repair decisions, optimized in terms of cost efficiency, under various discrete possibilities at the network level for each year (e.g. year 1, year 2, etc.). Afterwards, the MOST analysis may apply a network-level optimization that uses this pool to focus on the objective of maximizing asset condition on a network-level in a straightforward and simple formulation. MOST may include repair modeling and prioritization and fund allocation.

The MOST analysis may start by conducting a set of small asset-by-asset optimizations that determine the optimum repair scenarios in different years, for example for each of five consecutive years. The resulting pool of best yearly repairs may then be used as inputs to the network-level, to formulate yearly optimizations, each determining the assets worthy of repair. As such, both repair timings as well as repair types may be optimized.

Repair modeling may provide a representation of a repair scenario that can be used within a simple optimization formulation to determine the least-cost strategy to repair the defects in a given year, to an acceptable level. The process may be repeated for each year in the planning horizon separately to generate a pool of possible repairs, along with their cost estimates and expected condition improvement. Because it takes time to carry out multiple optimizations for each instance in the large building inventory, repair modeling can provide optimization using distributed processing time. As such, upon user entry of condition assessment data for any asset instance, the optimization process may be automatically activated to first generate a custom deterioration model, and then generate the best repair options. Therefore, repair modeling may be carried out in parallel with the condition assessment and deterioration modeling processes to save time.

To facilitate these decisions for a large-scale network of assets, the analysis may be segmented into a series of sequential optimizations to reduce problem size, without compromising the two objectives of best network condition and also best value for money. The MOST analysis may be performed first at the instance level. For example, given a 5-year planning horizon, five small optimizations may be carried out for each asset instance, separately, to determine the best repair scenario (cheapest repair to keep the instance at acceptable condition), one year at a time. Thus, each small optimization is only for one asset instance, one year. For example, in year 2 a best repair scenario for an asset instance may be to repair its defects no. 2, 4, and 5, while in year 3 its best repair scenario is to repair its defects no. 1, 2, 3 and 5. The resultant of all small optimizations in this example may comprise a pool of six best-repair scenarios for each asset instance (5 best repair scenarios in years 1 to 5, plus a do-nothing).

The whole pool for the asset instance may then be used as input to a network-level optimization that decides the asset instances' best repair timings. In essence, network-level optimization selects for example one of the six best-repair scenarios for each asset instance, so that the overall asset network condition is maximized over the planning horizon, respecting user defined constraints. For example, if the asset instance is decided to be repaired in year 2, then its best-repair action becomes automatically defined.

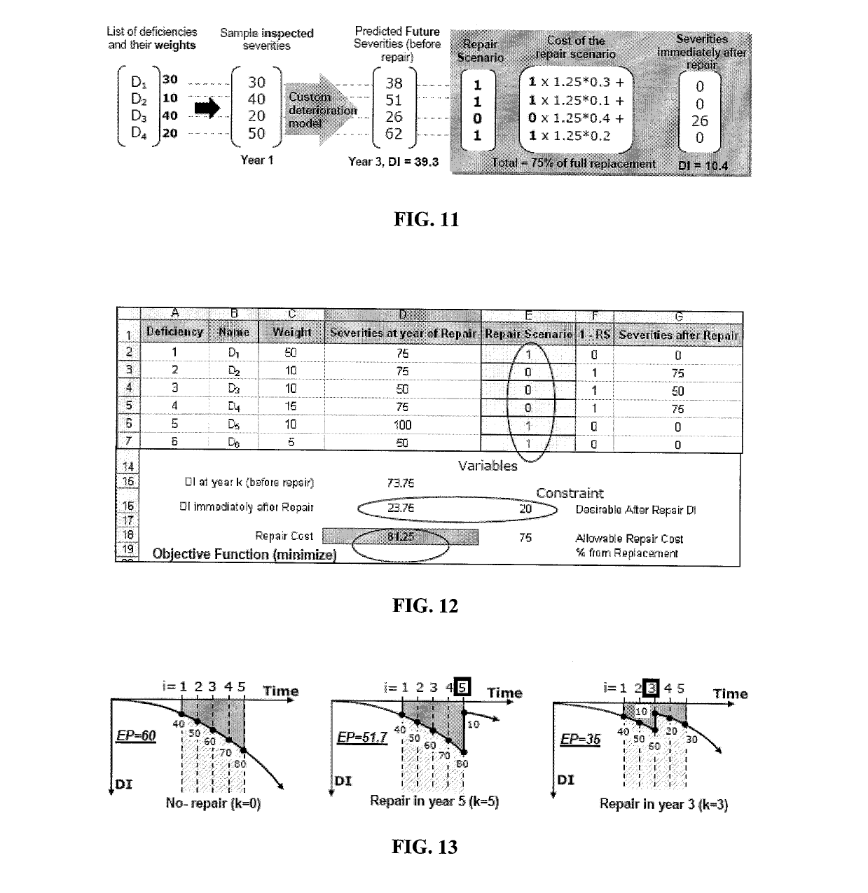

At the instance-level, it is possible to define a repair scenario (RS) as a combination of actions towards repairing a list of deficiencies based on their seventies. FIG. 11 illustrates a repair scenario for an asset having four deficiencies. For example, if the asset has four deficiencies (D1, D2, D3, and D4), one possible repair scenario is represented in the binary form as (1, 1, 0, 1), which implies repairing deficiencies D1, D2, and D4 and keeping deficiency D3 without repair. If the number of deficiencies is (d), then the possible number of repair scenarios in any year is equal to 2^{d}. All possible scenarios are assumed to be valid and feasible (a filter to check the practicality of any repair scenario may be optionally provided). Among the various repair scenarios, however, it may be necessary to identify the cheapest scenario that brings the condition of the instance to an acceptable level. To facilitate this analysis, the optimization algorithm may include a cost estimation model and also a model for estimating the resulting improvement in the instance condition due to the repair.

For each RS, it is possible to calculate its repair cost as a percentage of the total instance replacement cost, based on two simple assumptions: (1) repair cost for a defect (as a percentage of full replacement cost) is proportional to the weight of this defect; and (2) repairing one defect individually will cost for example 25% more than its share of replacement cost. Based on these two assumptions, the total cost (TC) of any repair scenario (as a percentage of the instance replacement cost) can be calculated by summing the costs of repairing all the defects of this scenario (Eq.2), as follows:

$$T C ( \% ) = {\sum }_{i = 1}^{d} 1.25 * {W}_{i} * {RS}_{i} \qquad ( 2 )$$

An example of this analysis is shown in FIG. 12, where a repair scenario is associated with a total cost of 75% of the instance replacement cost (calculated using Eq. 2). To convert repair cost to actual dollars, Eq. 3 may be applied as follows:

$IRCⱼ=TCⱼ×Zⱼ×$CRC

where, $IRC is the instance repair cost in dollars, TC is the repair cost (obtained from Eq. 2) as a percentage of instance replacement cost, (Z) is the instance relative size (e.g., 20% of roof area will be repaired), and the $CRC is the total replacement cost of the asset (e.g., all the roof). The $CRC can be obtained from the organization's replacement cost tables for any asset per unit (a unit can be square foot of gross school area or square foot of educational area).

In addition to estimating the cost of a repair scenario, it is possible to estimate the after-repair DI (ARDI). This is easily accomplished by looking at the repair scenario and assigning 0 severities to the defects that will be repaired (the last column in FIG. 13). Accordingly, carrying out a repair scenario (RS) in year k, the instance's after-repair condition (ARDIₖ) may be calculated using Eq. 4:

$$A R D {I}_{k} = \frac{{\sum }_{i = 1}^{d} {W}_{i} \cdot {S}_{ik} \cdot ( 1 - {RS}_{i} )}{100} \qquad ( 4 )$$

In the example repair scenario shown in FIG. 12, ARDI₃ is 10.4, which is a large improvement from the 39.3 deterioration index (DI) before repair. Upon formulating the analysis of any repair scenario, it is possible to analyze all the 2^{d} repair scenarios in each year using optimization to determine the best repair scenario for that year, and repeat the process for all the five years. The optimization variables are the repair options (1 or 0) associated with the defects. The objective function may be to minimize the repair cost (Eq. 2) under two constrains: (1) the after-repair deterioration ARDI should be less than or equal to a desired value (acceptable deterioration level); and (2) the cost should not exceed a given limit. In this formulation, the cheapest scenario that meets the acceptability level may be determined.

As an alternative to minimizing cost, it is also possible to maximize the benefit/cost (B/C) ratio of the repairs. This, however, may end up spending more on an instance to keep it at best condition. Because budget may be limited, a strategy that reduces expenditures and gives preference to critical instances may be used. It should be noted that the optimization algorithm need not use a fixed value for the acceptable deterioration constraint used in the optimization. Rather, a more practical approach may be to set the limit relative to the importance of the instance using a relative importance factor (RIF) that can be determined from historical data. The RIF values may range from 100 (most important) to 0 (least important) and reflect the asset's impact on safety, functionality, and other assets. The higher the RIF of an asset, the more desire to repair the asset to a better condition. Thus, the constraint for each asset may be set as (100-RIF). Because of the small size analysis involved, optimizing the repair scenario for an instance in a given year becomes fast and easy to do.

At the network-level, the small instance-level optimizations may be used. The instance-level optimizations produce best potential repair actions for each instance in alternative years 1 to 5. Added to these, a no repair (0) decision is also an option. It is possible then to consider this pool of best repairs as inputs to a network-level analysis to determine the best year to repair each asset instance. As the optimization will cover a large network of assets, it is expected to be a large-scale optimization problem. Hence, a non-traditional optimization technique, Genetic Algorithms (GA) is used, as an example of a large group of solutions called Evolutionary Algorithms that may be applied to that problem.

To formulate the network-level optimization, it is important to quantify both the benefit gained from a decision (selecting an instance for repair at a specific year), as well as the cost involved. Prioritization and fund allocation may provide a year-by-year formulation using Genetic Algorithms, and determine the best year of repair for each asset instance, maximizing network conditions. For larger numbers of asset instances, fund allocation based on simple ranking may be efficient.

In terms of benefit, it is possible to calculate a representation of the impact of selecting an instance (j) to be repaired in year (k), termed the “Expected Performance” (EPⱼₖ) of this instance, and evaluated at the network-level. Such performance embodies the impact of repair timing on the deterioration before-repair, the improvement due to repair, and the deterioration in future years. As such, the expected performance may be quantified as the average of the DI values of the various years (as shown in FIG. 13), using Eq. 5, as follows:

EPⱼₖ=Average(DIᵢ)ⱼ∀iεPlanning Horizon (5)

As shown in the example given in FIG. 13, in the case of no repair, the expected performance (average of all values shown) is 60, which indicates high deterioration. If this instance is repaired in the fifth year, the expected performance becomes 51.7, showing little improvement. However, if the instance is repaired in the third year, its expected performance improves to become 35. As such, the expected performance represents a single measure of the impact of a repair on the planning horizon. This measure, therefore, becomes useful at the network level.

Assuming that the repair-year decisions for the instances become known (after network-level optimization), the consequent network deterioration index (DI_{N}) can be calculated, on a scale from 0 to 100 for example, by averaging the instances' expected performances (EPs), weighted by their relative importance factors, as shown in Eq. 6:

$$D {I}_{N} = \frac{{\sum }_{j} ( R I {F}_{j} \times E {P}_{jk} )}{{\sum }_{j} R I {F}_{j}} \\ ∀ j ∈ the Network ( N ) \qquad ( 6 )$$

The network condition (DI_{N}) thus reflects the impact of the instances' repair timings on the overall network. It should be noted that as the decisions regarding the year of repair of each instance directly impact the network (DI_{N}), it may also accumulate repair costs for each year of the planning horizon. To optimize network-level decisions, the objective function may be to minimize the overall network deterioration index (Eq. 6) by selecting the best year to repair each asset. The yearly budget limits may represent the main constraint for the optimization (Eq. 7), where the sum of costs for all instances repaired in year (k) which should be less than the yearly budget in that year ($Bₖ), where $IRCⱼₖ is the instance's repair cost in year k, calculated using Eq. 4.

$${\sum }_{j} \$ I R {C}_{jk} \leq \$ {B}_{k} \\ ∀ k \qquad ( 7 )$$

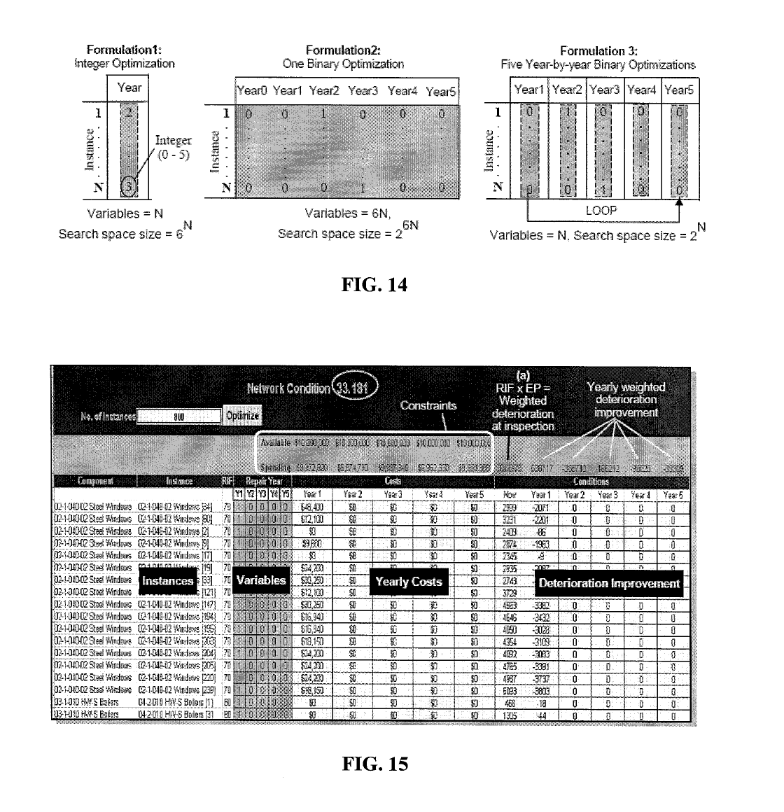

It is possible to design and implement network-level optimization in different ways; each has its unique formulation and corresponding solution quality. At least three alternatives may be provided, as illustrated in FIG. 14: integer optimization, one binary optimization and year-by-year binary optimizations.

Integer optimization provides an integer representation of N variables (for N instances), where each variable can take one of six values (0 to 5) representing the repair year. Alternatively, the one binary optimization may apply linear binary representation that considers all years at the same time. This, however, increases the number of variables to 6N. To reduce search space, therefore, a year-by-year binary optimization provides yearly optimizations of a much smaller search space (2^{N}) that may be used to determine the best decisions for each year, consecutively, that maximize the overall network condition at the end of the plan. One of the major benefits of this representation is that after the instances are selected in one year, they do not enter into competition in further years. As such, the yearly network optimizations become less in size, year after year. Also, the optimization maintains focus on one objective of maximizing overall network condition, without tradeoff, since the pool of decision options (repairs) was already optimized at the instance level in terms of cost efficiency. An example of applying year-by-year binary optimization using Genetic Algorithm based on historical data for all assets in the asset network is illustrated in FIG. 15.

### EXAMPLE

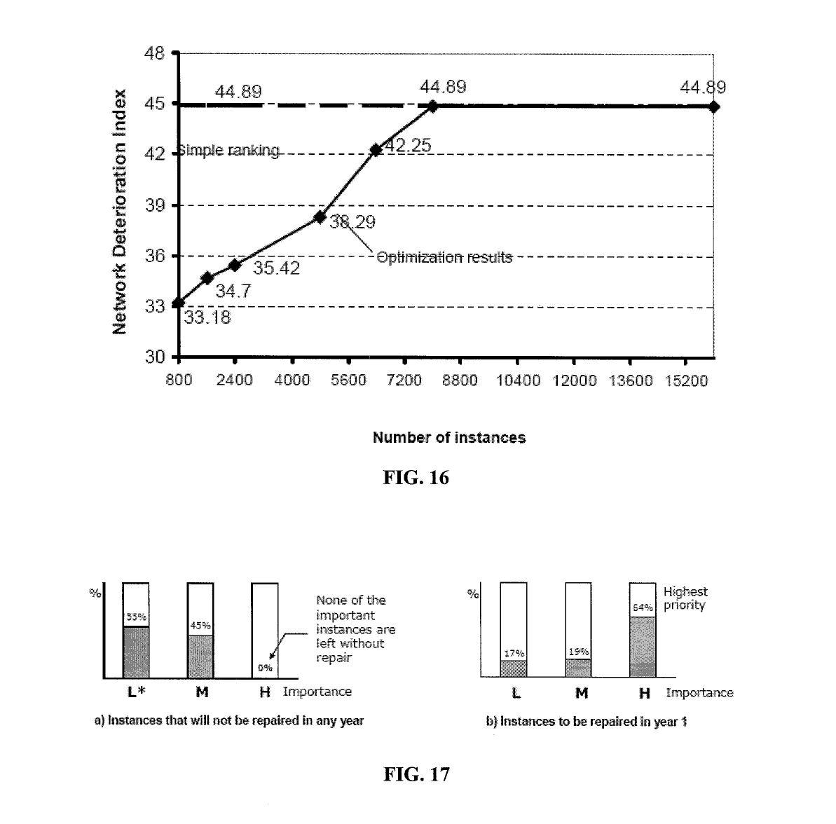

In a particular example, historical data was collected from the Toronto District School Board (TDSB) related to 800 asset instances from 40 schools. The asset instances represent the top assets of concern to the TDSB, including windows, roofing, boilers, and fire alarm systems. Once this historical data was entered and processed, various optimizations were conducted. A $10 million dollar yearly budget limit was used for the experiments to allow noticeable performance improvement to be made. Before optimization, the overall network condition was 54.32. To try improving network condition based on priority ranking, first, the instances were ranked based on their weighted before-repair condition (column (a) in FIG. 15) and repairs were allocated to top deteriorated instances in each year, successively, until the budget limit was exhausted. The result of this process (often the only mechanism used by asset owners) improved network condition to a deterioration level of only 44.89. An optimization experiment was then conducted on the 800 instances and the year-by-year optimization improved the overall network condition much further, to a deterioration level of 33.18, as shown in FIG. 16. Optimization took an average of five minutes each year to reach this result. This shows that optimization substantially improved network-level decisions.

The results of many other optimization experiments on networks with larger numbers of instances are summarized in FIG. 16. To facilitate comparison of results, larger-size networks were created by repeating the 800 instances several times, and adjusting the budget limit accordingly. As expected, there has been a noticeable degradation in optimization performance as the network size increases (search space gets exponentially larger). Despite the degradation, even at 6400 instances (320 schools simultaneously), optimization performance was still better than simple ranking. Thus it may also be beneficial to segment the network into subsets for separate optimization, if desired.

After the MOST analysis was carried out, an effort was made to test the results against a set of logical trends. FIG. 17 shows a portion of a simple statistical analysis of the results. As shown in the left side of the figure, the percentages of instances with high, medium, and low importance that were not repaired are shown and indicate that none of the instances with high importance were omitted. The right side also shows that a large percentage of the instances with high importance instances are selected for repair in year 1 (the rest of these high importance instances are repaired in the second year). It can be concluded from this simple test that the optimization provides reasonable selections for the instances to be repaired in various years of the plan. Such a simple test is beneficial and indicates the importance of establishing standard metrics to judge the performance of asset management systems, which is beyond the scope of this paper.

Based on its formulation and performance, the present invention proved to work efficiently as a repair-based asset management system. It has a unique focus on tracking the dynamics of defects in the various building assets and in optimally repairing these defects. The main strength of the system stems from its MOST integration of instance-level and network-level decisions.

Several extensions may be provided to the system of the present invention, including: adding a feedback mechanism to record and/or update actual costs and repair actions to help in refining repair estimates; applying the system to other types of assets; and using GIS and visualization techniques to present inputs and outputs, such as condition indices, level of funding, backlog, and actual versus planned data.

### EXAMPLE

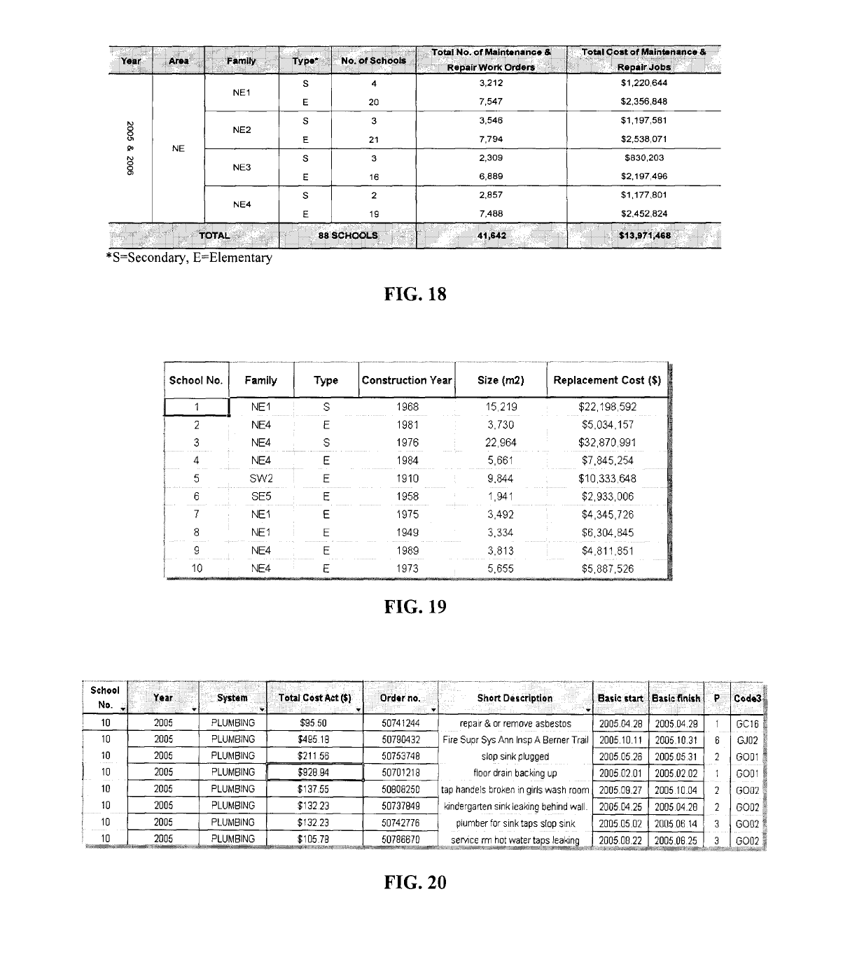

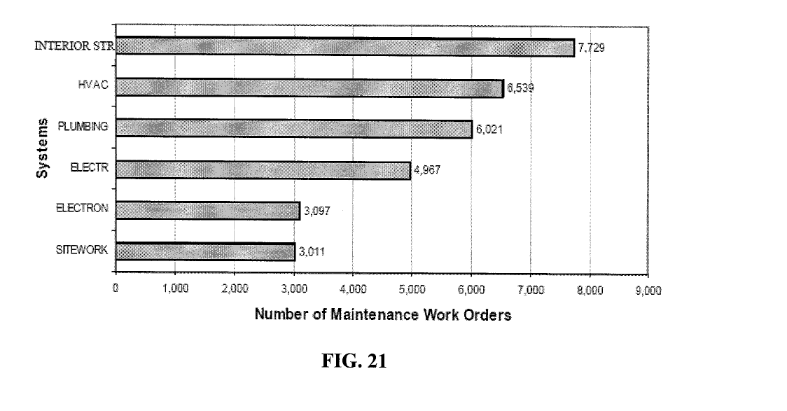

In another example, historical reactive-maintenance data for a sample of 88 schools were obtained from a SAP system at the TDSB (FIG. 18). The data in FIG. 19 all belong to one geographical area (North East, NE) out of four administered by the TDSB. Also, as shown in the table, four families of schools (each family contains about 24 schools) are sampled. From each sample school, two types of historical data were collected: (1) general school data (FIG. 19) which included information about the school type (elementary or secondary), construction year, size (in square metres), and replacement value (in dollars); and (2) maintenance work orders (FIG. 20) for the years 2005 and 2006, including work description, code, priority, actual cost, and repair duration. Data was collected for two years to ensure consistency in the conclusions to be drawn from one year to the next. Acquiring this data was an extensive task due to the large size and confidentiality of the data. A total of 41,642 work orders were extracted. Once the data were collected, the data was sorted, grouped, and linked to prepare the data for statistical analysis. Preliminary analysis of the data identified 23 building systems. The building that required the most maintenance (or repair work orders) are highlighted in FIG. 21.

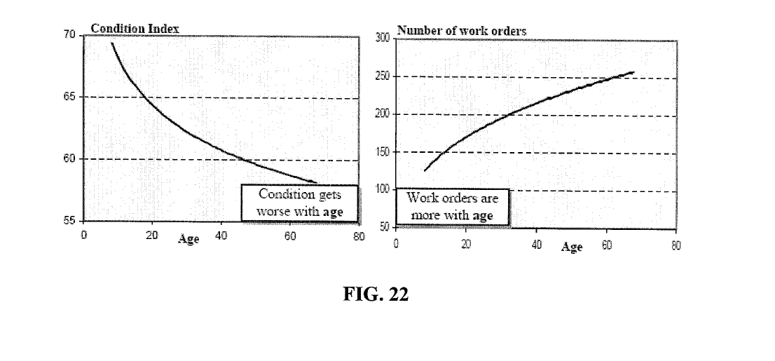

After preliminary analysis, the data of each building system was analyzed separately to test whether a relationship exists between the system condition and the yearly work orders. Such a relationship will be beneficial for predicting the condition of a system from available maintenance data, without inspection. As an example, the analysis was carried out on the 2005 and 2006 data for the HVAC systems. The results in FIG. 22 show logical trends: the older the system, the worse its condition, and consequently, the more the work orders it experiences. This proves that the number of work orders is a good indicator of condition. A similar analysis proved that the cost of work orders is another good indicator of the condition of assets.

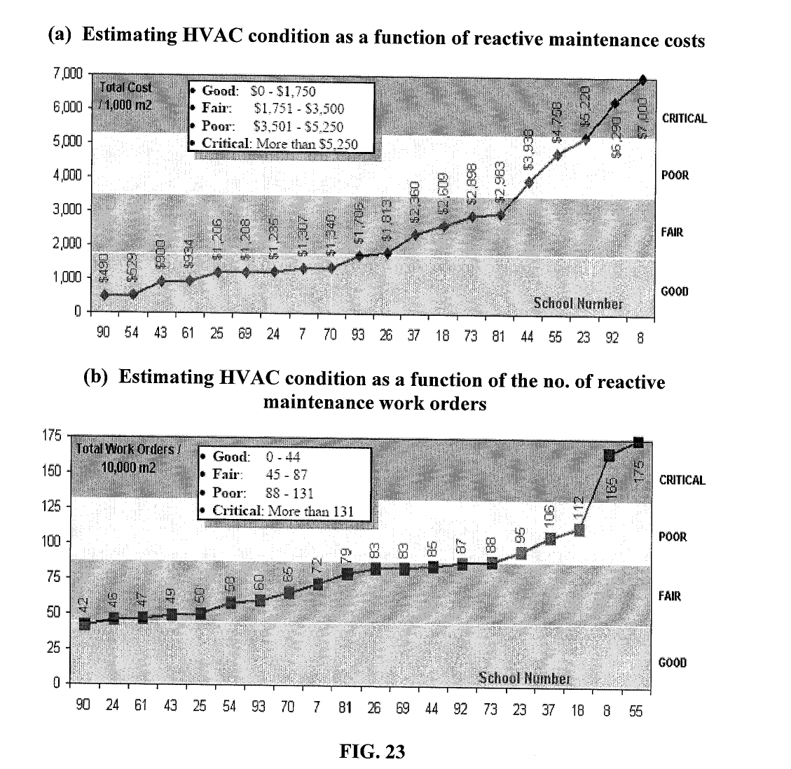

Based on the proven relationship shown in FIG. 22, analysis was continued to establish a condition indication mechanism. Because each family of TDSB schools has a consistent environment and similar demographical influences, a subset of the data that represents the HVAC systems in elementary schools of the NE1 family only were used in further analysis. This ensured the consistency in the behaviour of the HVAC systems across similar schools and makes the prediction system suitable to their environment. Using the HVAC data, as such, the two indicators of asset condition: “cost of work orders” and “number of work orders” were used to develop two charts, as shown in FIG. 23. FIG. 23a shows the total costs of the HVAC work orders (normalized based on school area) for each of the 20 schools in the NE1 family, sorted in an ascending order. This data was used to define four equal zones related to the Good, Fair, Poor, and Critical condition categories. The maintenance cost ranges that define the four condition categories were thus determined, as shown in FIG. 23a. Similarly, another chart (FIG. 23b) was generated to define the HVAC condition based on the total number of maintenance work orders. For validation purposes, different segments of the data (i.e., for different school families) were used to confirm the condition ranges defined. The result of this analysis shows that the condition ranges are reasonable and hence can be applied to the whole inventory of the TDSB schools. It also proves that the number of work orders and their associated costs are good indicators of condition.

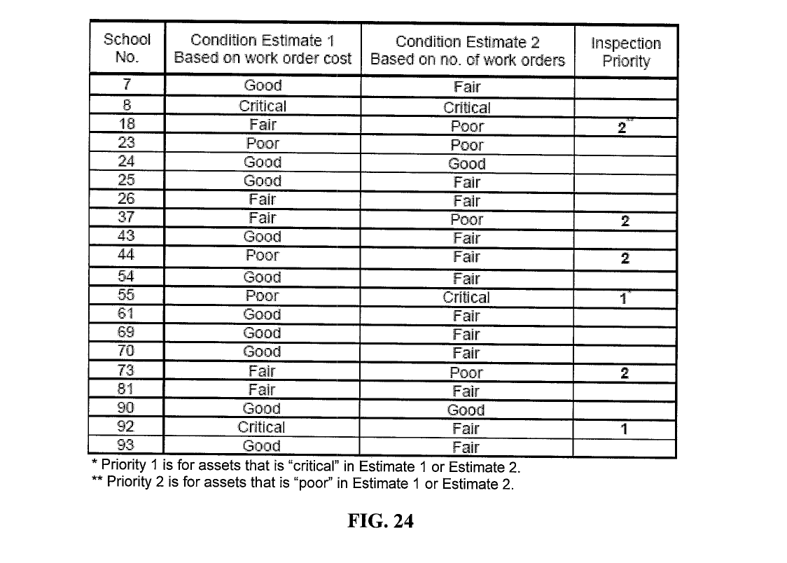

The condition ranges in FIG. 23 were then used to compare the predictions of condition based on cost versus those based on the number of work orders, as shown in FIG. 24. When the two condition predictions (Estimate 1 and Estimate 2 in FIG. 24) are similar, it represents a high degree of confidence in the predicted condition, thus eliminating the need to inspect that asset. Contradicting conditions, on the other hand, indicate some inconsistency and can thus be used to prioritize which inspection tasks are needed in order to verify the true condition. The last column in FIG. 24, for example, shows only six schools of the 20 being selected for inspection, where top priority is assigned to the schools that show a critical condition in either of the two predictions. It should be noted that the schools that show Fair and Good conditions for their assets are not given priority for inspection. Once this process is repeated and all the inspection tasks are defined and prioritized for all the building systems, it is possible to schedule them depending on the available inspection resources within the organization.

This process can be applied each year when all the reactive-maintenance data from the previous year is collected and used to estimate asset conditions and all the inspection tasks for the next year can then be defined. Thus, one of the key benefits of this condition prediction process is that it provides the ability to perform condition analysis on a yearly basis, without dependence on statistical deterioration models, which are inaccurate and require a great deal of data.

It should be understood that the deterioration model may be modified depending on the application of the technology of the present invention, and depending on the nature of the asset, while continuing the use of the two-stage optimization approach described herein.

It should be understood that this Example is provided to illustrate the operation of the present invention but is not meant to limit the application of the invention in any way. It will be understood by the skilled reader that the present invention can be used to provide asset management for optimizing inspection and allocation of renewal resources in a number of different areas. This is particularly the case where a relatively significant number of assets are under management, and there is disparity among the assets as to their life cycle. The present invention provides management an effective tool in allocating renewal resources efficiently. Furthermore, the task of collecting from the field up to date information regarding the current performance of assets is time consuming, and may require collection of the data from a variety of different locations that may be spread out geographically. The present invention makes the collection of the information systematically and accurately easy and efficient. Inspection of assets, compilation of data, and especially analysis of data for optimization purposes based on prior art methods may require the use of skilled staff. The present invention supports more accurate data collection, avoiding errors by guiding this systematic collection of the relevant information. Furthermore, the information collected is organized in the asset management database automatically or semi-automatically thus reducing the work required to support optimization of the use of the renewal resources.

The ability to analyze the information across multiple locations, asset types, problem severity and other categorizations enables the centralization of the renewal resource management role, for greater efficiency and also more expert exercise of this role. The built-in audit functionality described above also enables a manager remotely to selectively review the work of on-site inspectors in a way that is not possible based on prior art solutions. This allows improvements to be made in the quality of the information and based on this the allocation decisions made by the organization, by identifying problem areas in the work down by specific inspection personnel, for example by identifying the need for specific training, etc.

Other areas of application of the present invention include renewal of other assets such as oil and gas pipelines and refinery installations, industrial installations with multiple devices or components requiring renewal (such as for example production lines or assembly lines in manufacturing or processing), highway renewal, renewal of power distribution grids, or buildings with multiple renewal requirements (such as hospitals), and so on. It should be understood that the present invention may be modified for example as a fleet management tool, enabling for example ongoing collection of information regarding vehicle maintenance/renewal requirements, and optimization of allocation of maintenance/renewal resources.

1. A visual asset management system for optimizing inspection and allocation of capital renewal resources among a plurality of assets, at least two of the assets having different life cycles, the visual asset management system characterized by:
an inspection device linkable to an asset management database operable to store a life cycle performance for each of the plurality of assets, the inspection device comprising:
an inspection software utility that enables a user of the inspection device to (a) access an inspection template for conducting an inspection of the plurality of assets, and (b) collect and/or generate inspection data associated with a life cycle performance of the plurality of assets, the inspection data including one or more images representative of the life cycle performance of particular assets;
wherein the inspection device links or facilitates linking the inspection data with the corresponding asset in the asset management database so as to enable the analysis of the inspection data, including for allocation of renewal resources among the plurality of assets, or a sub-set of such assets.

2. The visual asset management system of claim 1, characterized in that the inspection device is a handheld computing device.

3. The visual asset management system of claim 1, characterized in that the inspection data comprises a performance and/or condition category for the asset.

4. The visual asset management system of claim 1, further characterized by an image obtaining means linked to the inspection device for generating the one or more images.

5. The visual asset management system of claim 1, characterized in that the visual inspection template includes a floor plan of a facility that includes one or more of the plurality of assets.

6. The visual asset management system of claim 5, characterized in that the floor plan is a two dimensional image.

7. The visual asset management system of claim 5, characterized in that the floor plan is a three dimensional model.

8. The visual asset management system of claim 5, characterized in that the user selects the asset for inputting inspection data by selecting the asset on the inspection device.

9. The visual asset management system of claim 1, characterized in that the visual asset management system is further characterized by an optimization engine linked to the asset management database, the optimization engine operable to optimize inspection and allocation of renewal resources among the plurality of assets, or a sub-set thereof, based on the inspection data stored in the asset management database.

10. The visual asset management system of claim 1, characterized in that the inspection device further comprises a positioning means that facilitates identification of assets on the visual inspection template.

11. The visual asset management system of claim 1, characterized in that the system includes or is linked to a geo-location utility for obtaining location data linkable to the inspection data so as to enable the localization of the assets and/or inspection data for the assets that relate to renewal requirements.

12. A visual asset management system for optimizing inspection and allocation of renewal resources among a plurality of assets, at least two of the assets having different life cycle, the visual asset management system characterized by:
an asset management database operable to store a life cycle performance for each of the plurality of assets;
an optimization engine linked to the asset management database; and
an inspection device linked to or linkable to the asset management database, the inspection device operable to enable a user thereof to: (a) access an inspection template for conducting an inspection of the plurality of assets, and (b) collect and/or generate inspection data associated with a life cycle performance of the plurality of assets, the inspection data including one or more images representative of the life cycle performance of particular assets;
wherein the inspection device links or facilitates linking the inspection data with the corresponding asset in the asset management database so as to enable the analysis of the inspection data, including allocation of renewal resources among the plurality of assets, or a sub-set of such assets.

13. The visual asset management system of claim 12, characterized in that the optimization engine further optimizes inspection and allocation of renewal resources based on historical data.

14. The visual asset management system of claim 13, characterized in that the historical data includes maintenance and repair data for the assets.

15. The visual asset management system of claim 12, characterized in that the optimization engine applies a two stage optimization algorithm, the first stage operable to optimize the inspection and allocation of renewal resources on an asset by asset basis, and the second stage operable to optimize the inspection and allocation of renewal resources across the plurality of assets based on the optimization from the first stage and one or more resource constraints.

16. The visual asset management system of claim 15, characterized in that the resource constraints are budget constraints.

17. The visual asset management system of claim 15, characterized in that optimizing inspection includes optimizing an inspection schedule, wherein the inspection schedule restricts inspection of the plurality of assets to a subset of the plurality of assets for a particular inspection period.

18. The visual asset management system of claim 17, characterized in that the subset of the plurality of assets is selected by analyzing the historical data for the assets to determine likely deterioration of each of the assets.

19. An asset management method for optimizing inspection and allocation of renewal resources among a plurality of assets, at least two of the assets having different life cycles, the asset management method characterized by:
(a) analyzing historical data for each asset to generate a pool of repair decisions for each of one or more renewal periods; and
(b) optimizing the repair decisions across all the assets in accordance with one or more constraints to allocate renewal of resources among all the assets for each of the renewal periods.
